(19) United States
(12) Patent Application Publication
(10) Pub. No.: US 2009/0248435 A1
(43) Pub. Date: Oct. 1, 2009

(54) Method for locating just in time mobile services

(76) Inventor: Sanjay Macwan, Marlboro, NJ (US)

Correspondence Address: AT & T Legal Department - WS;Attn: Patent Docketing, Room 2A-207, One AT & T Way, Bedminster, NJ, 07921, US

(21) Appl. No.: 12/080,000

(22) Filed: Mar. 31, 2008

(51) Int. Cl. G06Q 30/00; G01S 1/00

(52) U.S. Cl. 705/1; 342/357.09

(57) ABSTRACT

The current invention is based, at least in part, on the recognition that there is a problem of missed commercial opportunities when a commercial vendor is a mobile provider of goods or services. A need exists for facilitating communication between a mobile provider of goods or services and a potential recipient of those goods or services. Ideally, a solution to this need would not require a human dispatcher as an intermediary, due to various inefficiencies associated with such a method. In accordance with an aspect of the current invention, the limitation of missed business opportunities is avoided by (1) activating, by a mobile provider of commercial goods or services, a notification regarding availability to provide said commercial goods or services within a given distance of said mobile provider; and, (2) receiving, in response to said notification, and at a mobile location of said mobile provider of commercial goods or services, a request from a requester who is within the given distance of said mobile provider to provide said commercial goods or services to said requester. This method maximizes commercial opportunities between two parties without the need for a human dispatcher as an intermediary.

### BACKGROUND OF THE INVENTION

The present invention relates generally to facilitating a commercial relationship between two parties, and more particularly to facilitating a commercial relationship between a mobile provider of commercial goods or services and a potential customer.

A current business model in several industries is to offer goods and services to potential customers, (also called “requesters”), by means of a mobile business unit such a car, truck or van. Unlike traditional mortar and brick establishments where a potential recipient must travel to a location of a business in order to receive goods or services, mobile business units have the flexibility to travel to a requester. This mobility may be used by the business operator as an advantage over competitors in obtaining customers. Additionally, such mobility on the part of the service provider allows the goods or services to be provided relatively close to when a requester seeks goods or services. Furthermore, since the mobile provider may not have the overhead expenses of maintaining a mortar and brick establishment, the cost of providing the goods or services may be less than the mortar and brick based competition. This reduced cost can be passed on to a requester in terms of lower expenses, thus providing the mobile provider with a competitive advantage.

However, the inventors of the current invention have identified a significant problem which may arise in this business model. This is the problem of missed business opportunities. The problem of missed opportunities affects both the mobile provider as well as the potential recipient. Some causes of these missed opportunities are now described. First, a mobile provider of goods and services, during travel, does not know at which location his or her goods or services are needed at any given time.

Second, the mobile provider is limited in how he may advertise his goods or services. Some current methods of advertising include: a) decorating the vehicle in such a way that makes it clear that he seeks to provide goods or services; b) announcing his arrival on a loud speaker so that potential recipients are aware that certain goods or services are available; c) turning on a light on an overhead display indicating that he is available to provide goods or services; and d) advertising beforehand that he will be coming to a certain area and will be offering his goods or services.

These methods of attracting potential recipients, however, are not always effective. For example, a potential customer who is interested in certain goods or services which are offered by mobile providers does not know if such a mobile provider will be passing by at the time of a potential recipient's need for goods or services. Furthermore, even when the potential customer knows that there is a mobile provider located in close proximity, the potential customer has limited options for how to communicate his or her desire for the goods or services being provided. If the mobile provider does not pass by the location of the potential customer, or has already passed by this location, it is very difficult and often impractical for the potential recipient to effectively communicate with the mobile provider.

A few examples that illustrate the problem of missed commercial opportunities are as follows. First, a mobile ice cream truck is doing its rounds of various neighborhoods. A child runs out, after gathering the necessary money to buy his favorite treat, to greet the mobile ice cream truck only to find that the truck has already passed and is now out of the child's range of travel. Second, after a heavy snow fall, a home owner desires snow removal services. A snow plowing truck, doing the plowing rounds of a neighborhood to provide driveway snow removal, passes by the home owner's home at a moment when the home owner is not looking outside his window. Third, a pedestrian—motioning for a ride—watches in despair as an on-duty taxicab, vacant of passengers, rides by without seeing the pedestrian's motioning.

These above examples can be generalized to many mobile business service providers, (also called “mobile providers”), such as a mobile van providing a pet grooming service, a van providing a dry cleaning pick up and deliver service, a post office or parcel delivery company's pickup and drop-off truck, a mobile van providing on the spot windshield repair services, and even contractors such as driveway sealers, lawn maintenance providers, sprinkler maintenance providers, heating and air-condition service providers, plumbers, and electricians, just to name a few possibilities. These mobile providers, in general, wish to maximize use of their time and minimize their travel. For many of these mobile providers, and their prospective customers, missed commercial opportunities continue to frustrate both parties.

Some methods of helping two parties who want to enter into a commercial relationship with each other—where at least one of the parties is mobile—have been implemented in various industries. For example, when a person travels to a new area, he or she may want to locate and obtain certain goods or services in that new location. This traveler may initiate a search using, for example, a cellular network service provider to find local mortar and brick business establishments in proximity to the traveler. However, this method does not provide a means for determining proximity of a mobile provider, whose location may be changing at any given moment, to the traveler.

Another method of helping one party locate another party, where at least one of the parties is mobile, is a service called Loopt. The Loopt service lets a friend find another friend's location within a particular area. Additionally, the Loopt service may give an alert when one's friend is nearby. In one alternative, the Loopt system uses global positioning to automatically update at least one of the two party's location. However, the Loopt system does not focus on matching a potential recipient of goods or services with a mobile provider of goods or services. Additionally, the Loopt system does not inform a potential customer regarding a mobile provider's current willingness and availability to provide goods or services.

Another method for connecting two parties where at least one of the parties is mobile is a human dispatching service. A dispatcher service utilizes a human intermediary to connect two parties with each other when one party has a need for something which the other party is providing. Commercial examples which use a dispatcher service include the taxicabs and car services as well as tow-trucks and other car assistance services. Non-commercial examples include emergency and non-emergency assistance personal, such as police, fire and ambulance services. The dispatcher service in these industries matches a requester of a service with a mobile provider of the service. The dispatcher contacts the mobile provider of the service and directs the provider to the requester, such as contacting a taxicab to provide a customer with a ride.

However, a dispatcher system may be impractical or ineffective for several reasons. One reason is the expense incurred when using a human intermediary as the dispatcher. Another reason is a lacking of sufficient need to justify using a human in this role. For example, if a mobile provider can only perform a few services per day, having a human dispatcher attending a telephone line for the whole day may be impractical. A third reason is that some delay may be involved with utilizing a third party dispatcher. This delay may be critical when the goods or services are such that they must be provided within a relatively short time period. One example may be an ice cream truck. When the truck is circulating through various neighborhoods, it is not always practical to circle back to a previous neighborhood, due at least partially to the opportunity cost of delaying service to future customers.

The current invention is based, at least in part, on recognition that there continues to be a problem of missed commercial opportunities when the commercial vendor is a mobile provider of goods or services. These missed commercial opportunities continue to frustrate both mobile providers of commercial goods or services as well as potential recipients of these goods or services. Therefore, a need exists to facilitate communication between a mobile provider and a potential customer—without requiring the assistance of a human intermediately.

### BRIEF SUMMARY OF THE INVENTION

The limitation of a mobile provider of commercial goods or services missing an opportunity to provide those goods or services to a potential customer located in vicinity of the mobile provider—without the assistance of a human dispatcher—is avoided by the following. In accordance with an aspect of the current invention, the prior mentioned limitation is avoided by (1) activating, by a mobile provider of commercial goods or services, a notification regarding availability to provide said commercial goods or services within a given distance of said mobile provider; and, (2) receiving, in response to said notification, and at a mobile location of said mobile provider of commercial goods or services, a request from a requester who is within the given distance of said mobile provider to provide said commercial goods or services to said requester.

In accordance with an embodiment of the invention, the mobile provider transmits information pertaining to his availability to provide the requested commercial goods or services. This transmission may be made from the mobile location of the mobile provider.

In accordance with another embodiment of the invention, the mobile provider receives an authorization to provide the requested goods or services. The mobile provider may receive this authorization at the mobile location.

In accordance with a further embodiment of the invention, a mobile location of the mobile provider may be determined utilizing any locating means known in the art. In one embodiment, this locating means is a global positioning system enabled device located at the mobile location.

In accordance with another embodiment of the invention, a cellular telephone network service provider receives the activation notification from the mobile provider.

In accordance with a further embodiment of the invention, the cellular telephone network service provider may provide contact information about at least one mobile provider to a requester. This information may include only mobile provider that is closest to the requester. Alternatively, the provided information may include all the mobile providers whose range of coverage includes the requester.

In accordance with another embodiment of the invention, the mobile provider receives a given time period in which the desired commercial goods or services must be provided. The mobile provider may then transmit an indication of availability to provide said requested commercial goods or services as a function of said given time period and an estimated trip time.

These and other advantages of the invention will be apparent to those of ordinary skill in the art by reference to the following detailed description and the accompanying drawings.

### BRIEF DESCRIPTION OF THE DRAWINGS

FIG. 1 is a schematic representation of a human dispatcher communication system.

FIG. 2 is a schematic representation of an embodiment of the current invention.

FIG. 3 is a flowchart which illustrates an embodiment of the current invention.

FIG. 4 is a flowchart which illustrates an embodiment of the current invention in which the goods or services must be provided within a given time period.

### DETAILED DESCRIPTION

One of the well known business models involves a brick and mortar location where goods or services are offered to potential customers. Another well known business model involves a mobile provider of goods or services traveling through areas where potential customers are found hoping that some of these potential customers will avail themselves of the goods or services for sale. The latter method has several advantages over the former method. The mobile provider's ability to bring goods and service to a potential customer's location allows for the possibility of providing these goods or services relatively close in time to when a potential recipient seeks them. Additionally, since the mobile provider may not have the overhead expenses of maintaining a mortar and brick establishment, the cost of the goods or services provided may often be less than the mortar and brick based competition. Furthermore, the potential customer may need the goods for or services on something which cannot be easily transported from its current location.

However, the inventors of the current invention have identified a significant problem which may arise in this business model. This is the problem of missed business opportunities. Missed business opportunities affect both the mobile provider as well as the potential recipient, since each party desires to establish a commercial relationship with the other party. This problem has at least a few root causes. First, the mobile provider of goods and services, during travel, may not know at which location his or her goods or services are needed at any given time. Second, the mobile provider is limited in how he may advertise his goods or services. Some current methods of advertising include: decorating the vehicle in such a way that makes it clear that he seeks to provide goods or services; announcing his arrival on a loud speaker so that potential recipients are aware that certain goods or services are available; turning on a light on an overhead display indicating that he is available to provide goods or services; and advertise beforehand that he will be coming to a certain area and will be offering his goods or services. Unfortunately, each of these methods has gaps and is prone to missed commercial opportunities.

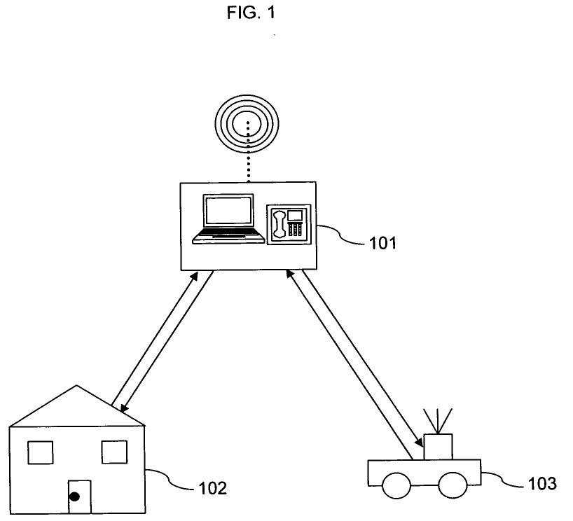

One solution offered to the problem of missed commercial opportunities is a human dispatcher system. This system is illustrated in FIG. 1 with a schematic representation. A requester 102 of commercial goods or services desires to receive these goods or services from a mobile provider 103. In order to contact the mobile provider, the requester calls a telephone number which connects the requester to a human dispatcher 101. The requester may require that the goods or services be provided within a certain given time period. The human dispatcher then proceeds to contact the mobile provider to see if the mobile provider is available and ascertain whether the goods or services can be provided within the given time period.

However, this dispatcher system may be impractical for several reasons. One reason is the expense incurred when using a human intermediary as the dispatcher. Another reason is a lacking of sufficient need to justify using a person in this role. For example, if a mobile provider can only perform a few services per day, having a human dispatcher attending a telephone line for the whole day may be impractical. A third reason is that some delay may be involved with utilizing a third party dispatcher. This delay may be critical when the goods or services are such that they must be provided within a relatively short time period.

Therefore, despite attempts to address the problem, missed commercial opportunities continues to frustrate both mobile providers of goods or services and potential consumers of these goods or services.

The limitation of a mobile provider of commercial goods or services missing an opportunity to provide these goods or services to a potential customer located in vicinity of the mobile provider—without the assistance of a human dispatcher—is avoided by the following. In accordance with aspect of the current invention, the prior mentioned limitation is avoided by (1) activating, by a mobile provider of commercial goods or services, a notification regarding availability to provide said commercial goods or services within a given distance of said mobile provider; and, (2) receiving, in response to said notification, and at a mobile location of said mobile provider of commercial goods or services, a request from a requester who is within the given distance of said mobile provider to provide said commercial goods or services to said requester. The invention maximizes business opportunities for the provider—especially within a given area in which the provider is located at a given time—and also provides greater convenience and a significantly improved service experience to the requester.

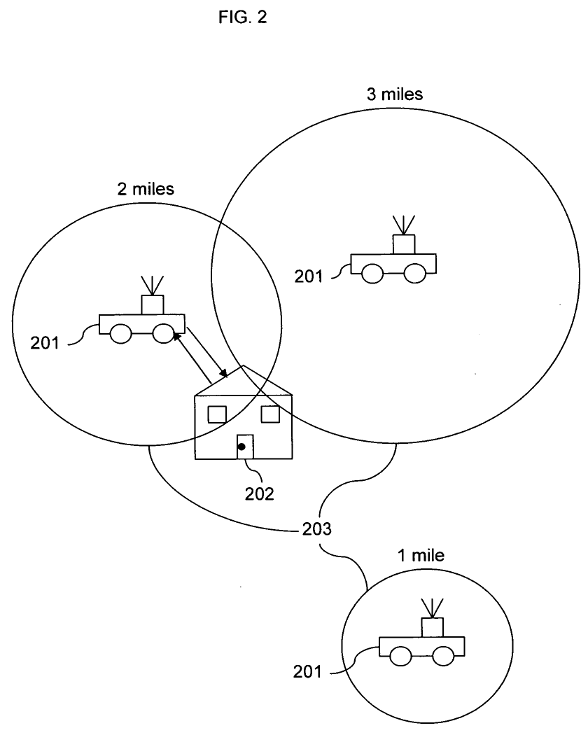

FIG. 2 is a schematic representation of an embodiment of the current invention. Three mobile providers of commercial goods or services 201 are shown in the figure. Each mobile provider has chosen a different radius of coverage 203. Factors that may determine what radius of coverage a mobile provider chooses include how much they need new commercial opportunities, how quickly their consumers typically want to receive their goods or services, and their mobility—just to name a few factors. In this embodiment, three different radii of coverage were chosen, one, two and three miles. In one embodiment, a notification of the radius of coverage chosen by a mobile provider is transmitted to a cellular telephone network service provider.

When a potential customer (also called a “requester”) 202 wants to initiate a receipt of commercial goods or services, the requester looks to contact a nearby mobile provider. Various possibilities exist for how the requester will receive information regarding a mobile provider. For example, the requester may receive from a cellular network service provider, (also called a “service provider”), all mobile providers that are offering these goods or services within range of the requester. Alternatively, the service provider may only transmit the identification of the mobile provider closest to the requester. The service provider may determine a location of a mobile provider and a requester by utilizing global positioning system enabled devices located in proximity to the two parties. Alternatively, the two parties may report their locations. This alternative is better suited for when the parties are static or will not be moving for an extended period of time. Other alternatives exist for how the service provider obtains the location information.

In this embodiment, the requester may have a device at his premises which displays the mobile provider information received from the service provider. The device could be a cellular telephone, a PDA, a navigation device, a personal computer, or any other device capable of receiving this distance information. The requester may then contact the mobile provider which is closest to him in order to attempt to receive the promptest service. In alternative embodiments, the PDA can display a menu that shows service providers in the requester's area. The menu could be updated as providers entire and leave the area.

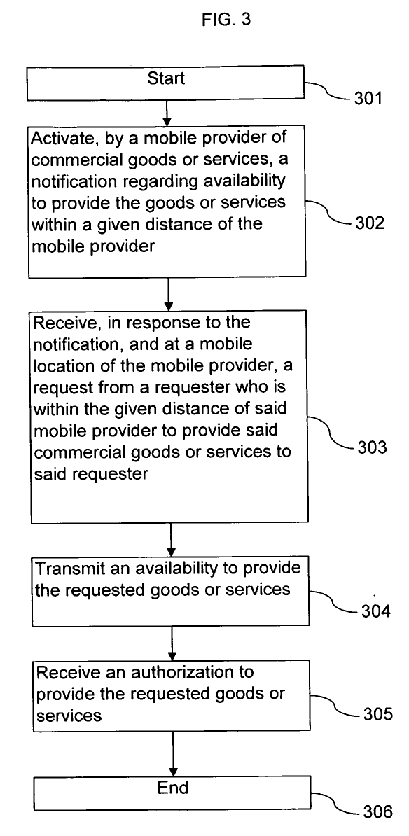

FIG. 3 is a flowchart which illustrates an embodiment of the current invention. The method begins at step 301. At step 302, a mobile provider of commercial goods or services activates a notification regarding availability to provide said commercial goods or services within a given distance of said mobile provider.

At step 303, in response to the notification, and at a mobile location of the mobile provider, a request is received from a requester, who is within the given distance of said mobile provider, to provide said commercial goods or services to said requester. The requester may receive contact information about a mobile provider even if the requester is not within the given distance of the mobile provider. Alternatively, the requester may only receive the contact information if the requester is within the given distance of the mobile provider.

At step 304, the mobile provider transmits to the requester, from the mobile location of the mobile provider, his availability to provide the requested commercial goods or services.

At step 305, the mobile provider receives at his mobile location an authorization, from the requester, to provide the requested commercial goods or services.

This method ends at step 306.

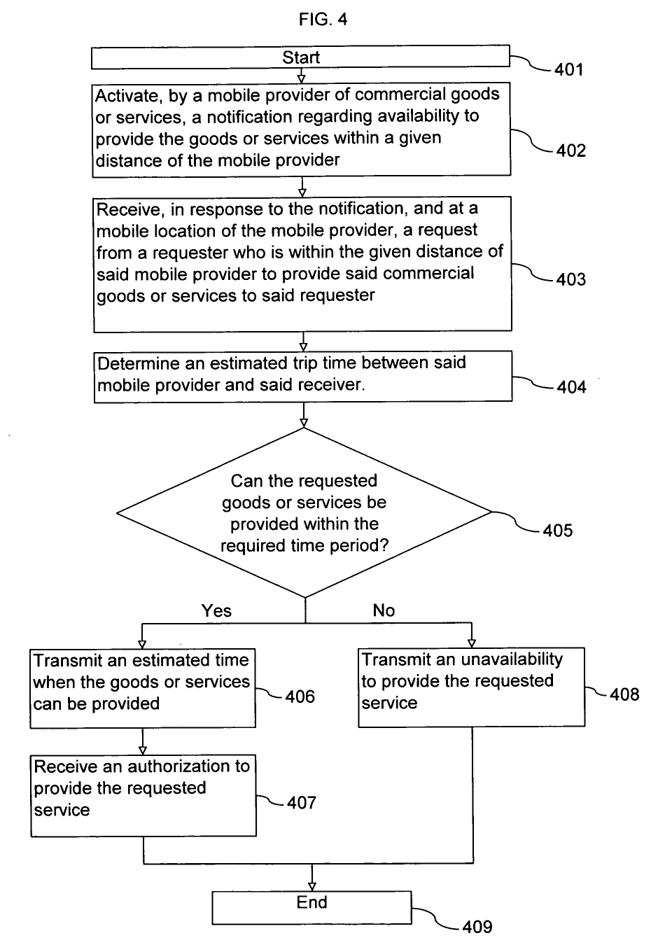

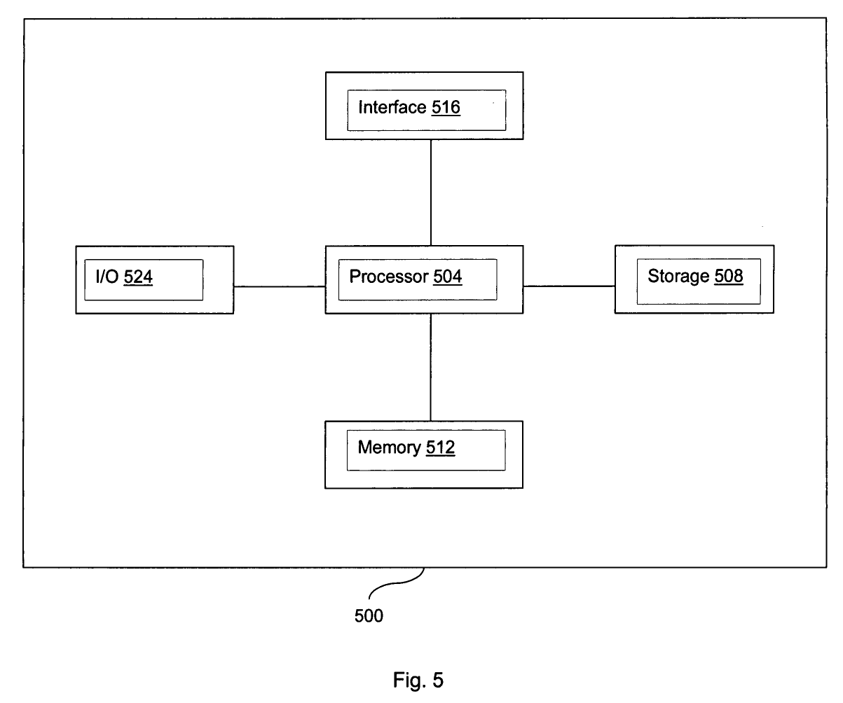

FIG. 4 is a flowchart which illustrates an embodiment of the current invention in which the goods or services must be provided within a given time period. The method begins at step 401. At step 402, a mobile provider of commercial goods or services activates a notification regarding availability to provide said commercial goods or services within a given distance of said mobile provider.

At step 403, in response to the notification, and at a mobile location of the mobile provider, a request is received from a requester who is within the given distance of said mobile provider to provide said commercial goods or services to said requester. The requester may receive contact information about a mobile provider even if the requester is not within the given distance of the mobile provider. Alternatively, the requester may only receive the contact information if the requester is within the given distance of the mobile provider.

At step 404, an estimated trip time between said mobile provider and said receiver is determined. This estimated trip time may be determined by a cellular telephone network service provider. Alternatively, the estimated trip time may be determined by a device located in proximity to the mobile provider or the requester. In one embodiment, an estimated trip time between a mobile provider and a requester is determined by utilizing a navigation program.

At step 405, it is determined if the requested goods or services can be provided within the required time period. In one embodiment, this determination is made by the mobile provider and is the combination of at least two factors. The first factor is the trip time between the mobile provider and the requester. The second factor is the availability of the mobile provider to provide the goods or services. The mobile provider may, for example, currently be occupied with another requester. In such a case, the mobile provider would not be available until after he has finished providing the goods or services to the other requester.

If the mobile provider is able to provide the goods or services within the required period of time, then the method continues at step 406. At this step, the mobile provider transmits an estimated time when the goods or services can be provided. As discussed previously, some factors that effect this time are the trip time between the mobile provider and the requester and the mobile provider's availability.

At step 407, the mobile provider receives an authorization to provide the requested service from the requester. The method then ends at step 409.

However, if the mobile provider is not able to provide the goods or services within the required period of time, then the method continues at step 408. At this step, the mobile provider transmits a notification regarding unavailability to provide the requested goods or services within the required time period. The method ends at step 409.

FIG. 5 shows a high-level block diagram of a computer that may be used to carry out the invention. Computer 500 contains a processor 504 that controls the overall operation of the computer by executing computer program instructions which define such operation. The computer program instructions may be stored in a storage device 508 (e.g., magnetic disk, database) and loaded into memory 512 when execution of the computer program instructions is desired. Thus, the computer operation will be defined by computer program instructions stored in memory 512 and/or storage 508, and the computer will be controlled by processor 504 executing the computer program instructions. Computer 500 also includes one or a plurality of input network interfaces for communicating with other devices via a network (e.g., the Internet). Computer 500 also includes one or more output network interfaces 516 for communicating with other devices. Computer 500 also includes input/output 524 representing devices which allow for user interaction with the computer 500 (e.g., display, keyboard, mouse, speakers, buttons, etc.). One skilled in the art will recognize that an implementation of an actual computer will contain other components as well, and that FIG. 5 is a high level representation of some of the components of such a computer for illustrative purposes. It should also be understood by one skilled in the art that the method of the current invention may be implemented on a device such as is shown in FIG. 5.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
activating, by a mobile provider of commercial goods or services, a notification regarding availability to provide said commercial goods or services within a given distance of said mobile provider;
receiving, in response to said notification, and at a mobile location of said mobile provider of commercial goods or services, a request from a requester who is within the given distance of said mobile provider to provide said commercial goods or services to said requester, and further receiving a given time period by which said commercial goods or services must be provided to said requester:
determining an estimated trip time between said mobile provider and said requester: and
transmitting, from said mobile location of said mobile provider to said requester, an indication of availability to provide said requested commercial goods or services as a function of said given time period and said estimated trip time.

2. The method of claim 1 wherein a location of said mobile provider is determined utilizing a global positioning system enabled device located at said mobile location of said mobile provider.

3. The method of claim 1 further comprising:
transmitting, from said mobile location of said mobile provider to said requester, an indication of availability to provide said requested commercial goods or services.

4. The method of claim 3 further comprising:
receiving, at said mobile location of said mobile provider from said requester, authorization to provide said requested commercial goods or services.

5. (canceled)

6. The method of claim 1 further comprising:
transmitting, from said mobile location of said mobile provider to said requester, an indication of availability to provide said requested commercial goods or services within said given time period.

7. The method of claim 6 further comprising:
receiving, at said mobile location of said mobile provider from said requester, authorization to provide said requested commercial goods or services.

8. The method of claim 6, wherein the step of transmitting an indication of availability further comprises:
transmitting an estimated time when said goods or services will be provided.

9-10. (canceled)

11. A method comprising:
receiving, by a cellular network service provider, a notification from a mobile provider of commercial goods or services, said notification informing the cellular network service provider of an availability of the mobile provider to provide said commercial goods or services within a given distance of said mobile provider;
receiving, by the cellular network service provider, a request for said commercial goods or services from a requester for commercial goods or services, the request further including a given time period by which said commercial goods or services must be provided to said requester:
determining an estimated trip time between said mobile provider and said requester; and
transmitting, to said requester, contact information for said mobile provider, when said requester is located within said given distance of said mobile provider, and further transmitting an indication of availability to provide said requested commercial goods or services as a function of said given time period and said estimated trip time.

12. The method of claim 11, wherein the step of transmitting contact information further comprises:
transmitting contact information for a closest mobile provider when said requester is located with said given distance of more than one mobile provider.

13. A computer readable medium, comprising computer program instructions capable of being executed in a processor and defining the steps comprising:
activating, by a mobile provider of commercial goods or services, a notification regarding availability to provide said commercial goods or services within a given distance of said mobile provider;
receiving, in response to said notification, and at a mobile location of said mobile provider of commercial goods or services, a request from a requester who is within the given distance of said mobile provider to provide said commercial goods or services to said requesters
receiving a given time period by which said commercial goods or services must be provided to said requester:
determining an estimated trip time between said mobile provider and said requester: and
transmitting, from said mobile location of said mobile provider to said requester, an indication of availability to provide said requested commercial goods or services as a function of said given time period and said estimated trip time.

14. The computer readable medium of claim 13, wherein a location of said mobile provider is determined utilizing a global position system enabled device located at said mobile location of said mobile provider.

15. The computer readable medium of claim 13 wherein the instructions further comprise the step of:
transmitting, from said mobile location of said mobile provider to said requester, an indication of availability to provide said requested commercial goods or services.

16. The computer readable medium of claim 15, wherein the instructions further comprise the step of:
receiving, at said mobile location of said mobile provider from said requester, authorization to provide said requested commercial goods or services.

17. (canceled)

18. The computer readable medium of claim 13, wherein the instructions further comprise the step of:
transmitting, from said mobile location of said mobile provider to said requester, an indication of availability to provide said requested commercial goods or services within said given time period.

19. The computer readable medium of claim 13, wherein the instructions further comprise the step of:
receiving, at said mobile location of said mobile provider from said requester, authorization to provide said requested commercial goods or services.

20. The computer readable medium of claim 18, wherein the step of transmitting an indication of availability further comprises: transmitting an estimated time when said goods or services will be provided.

21-22. (canceled)
